(19) United States
(12) Patent Application Publication
(10) Pub. No.: US 2023/0188023 A1
(43) Pub. Date: Jun. 15, 2023

(54) POSITIONING PLATFORM BASED ON ELECTROMAGNETIC ACTUATOR

(71) Applicant: ZJU-HANGZHOU GLOBAL SCIENTIFIC AND TECHNOLOGICAL INNOVATION CENTER, Hangzhou (CN)

(72) Inventor: Ning LI, Hangzhou (CN)

(21) Appl. No.: 18/095,544

(22) Filed: Jan. 11, 2023

Related U.S. Application Data
(63) Continuation of application No. PCT/CN2022/134009, filed on Nov. 24, 2022.

(30) Foreign Application Priority Data
Dec. 13, 2021 (CN) 202111517303.7

(51) Int. Cl. H02K 41/03

(52) U.S. Cl. CPC H02K 41/031

(57) ABSTRACT

A positioning platform based on an electromagnetic actuator is provided. The positioning platform includes: an actuator stator component, an actuator mover component, a moving platform component, and a deceleration driving component. The actuator stator component is provided with a sliding guidance groove. The actuator mover component is disposed in the actuator stator component and capable of sliding by electromagnetic force along the sliding guidance groove. The actuator mover component is capable of driving the moving platform component to slide along the sliding guidance groove. An end of the deceleration driving component is connected to the actuator mover component, the other end is connected to the moving platform component. The actuator mover component is capable of selectively driving the moving platform component to move at different speeds by the deceleration driving component.

### CROSS-REFERENCE TO RELATED APPLICATIONS

This application is a continuation of international application No. PCT/CN2022/134009 filed on Nov. 24, 2022, which claims priority to Chinese patent application No. 202111517303.7, filed on Dec. 13, 2021, titled “HIGH-PRECISION, VARIABLE-SPEED, GREAT-LOAD POSITIONING PLATFORM BASED ON ELECTROMAGNETIC ACTUATOR”. The contents of the above identified application are hereby incorporated herein in their entireties by reference.

### TECHNICAL FIELD

The present disclosure generally relates to the field of a motion displacement platform, and in particular, to a positioning platform based on an electromagnetic actuator.

### BACKGROUND

A conventional actuator such as a ball screw is commonly used in a commercial liner positioning platform. Due to a long transmission chain and a large cumulative system error of the conventional actuator such as the ball screw, transmission accuracy and response speed of the conventional actuator can no longer meet a current demand for precision linear driving. A guide slider with the ball screw is used in most of relevant commercial liner positioning platforms, and the guide slider with the ball screw can only be disposed at fixed points. In a case of a great load, a pressure near the guide slider with the ball screw may be too great and the guide slider with the ball screw may easily be damaged, resulting in shortening service life of the liner positioning platform. In addition, speed of the relevant commercial liner positioning platform is difficult to be flexibly switched according to an application scenario.

### SUMMARY

According to various embodiments of the present disclosure, the present disclosure provides a positioning platform based on an electromagnetic actuator.

The positioning platform based on the electromagnetic actuator includes an actuator stator component, an actuator mover component, a moving platform component, and a deceleration driving component. The actuator stator component is provided with a sliding guidance groove. The actuator mover component is disposed in the actuator stator component and capable of sliding by electromagnetic force along the sliding guidance groove defined by the actuator stator component. The actuator mover component is capable of driving the moving platform component to slide along the sliding guidance groove defined by the actuator stator component. An end of the deceleration driving component is connected to the actuator mover component, and the other end of the deceleration driving component is connected to the moving platform component. The actuator mover component is capable of selectively driving the moving platform component to move at different moving speeds by the deceleration driving component.

In some embodiments, the actuator stator component includes an actuator stator frame and permanent magnets disposed at both sides of the actuator stator frame. The actuator mover component includes a rack and actuator movers disposed at both sides of the rack, and the actuator movers are disposed corresponding to the permanent magnets.

In some embodiments, the actuator stator frame is provided with grooves at both sides, and the grooves are configured to hold the permanent magnets.

In some embodiments, the positioning platform based on the electromagnetic actuator further includes a sliding guidance component. The sliding guidance component is disposed between the actuator stator component and the actuator mover component and capable of sliding and guiding the actuator mover component to slide.

In some embodiments, the sliding guidance component includes a connecting plate, a plurality of holders, and a plurality of balls. The connecting plate is connected to a bottom of the rack. The plurality of holders is disposed on the connecting plate and capable of rolling about axes of the plurality of holders and relative to the connecting plate. The plurality of balls is disposed on the plurality of holders and capable of rolling about axes of the plurality of balls relative to the plurality of holders, respectively.

In some embodiments, the deceleration driving component is capable of switching between a first operation mode and a second operation mode. When the deceleration driving component is in the first operation mode, the moving platform component moves at a first speed. When the deceleration driving component is in the second operation mode, the moving platform component moves at a second speed different from the first speed.

In some embodiments, the deceleration driving component includes a fixed base plate, a mounting bracket, and a transmission component. The fixed base plate is fixed to the actuator stator frame and configured to guide the moving platform component. The mounting bracket is fixed to the fixed base plate. The transmission component is connected to the mounting bracket. The transmission component is capable of switching between a first state and a second state. When the transmission component is in the first state, the deceleration driving component is in the first operation mode. When the transmission component is in the second state, the deceleration driving component is in the second operation mode.

In some embodiments, the transmission component includes a first primary speed gear, a second primary speed gear, a first speed-increasing gear, a second speed-increasing gear, a transmission gear, a power shaft, and an electromagnetic clutch. All of the first primary speed gear, the second primary speed gear, the first speed-increasing gear, and the second speed-increasing gear are rotatably disposed on the mounting bracket. The second primary speed gear is engaged with the first primary speed gear and a primary speed rack gear disposed on the moving platform component, respectively. The second speed-increasing gear is engaged with the first speed-increasing gear and a speed-increasing rack gear disposed on the moving platform component, respectively. The power shaft rotatably extends through the first primary speed gear and the first speed-increasing gear. The transmission gear is connected to the power shaft and engaged with a transmission rack gear disposed on the rack. The electromagnetic clutch is slidably and mounted to the power shaft and capable of standstill locking relative to the power shaft, and the electromagnetic clutch is located between the first primary speed gear and the first speed-increasing gear. When the electromagnetic clutch is engaged with the first primary speed gear, the electromagnetic clutch transmits transmission force of the power shaft to the first primary speed gear. When the electromagnetic clutch is engaged with the first speed-increasing gear, the electromagnetic clutch transmits the transmission force of the power shaft to the first speed-increasing gear.

In some embodiments, the transmission component includes two first primary speed gears, two second primary speed gears, two first speed-increasing gear, two second speed-increasing gear, and the electromagnetic clutch. The two first primary speed gears are disposed at both sides of the transmission gear, respectively. The two first speed-increasing gears are disposed at both sides of the two first primary speed gears, respectively.

In some embodiments, the moving platform component includes an upper connecting plate and vertical plates disposed at both sides of the upper connecting plate. The fixed base plate extends through sliding grooves on the vertical plates to guide the vertical plates to slide. Both the primary speed rack gear and the speed-increasing rack gear are disposed on the upper connecting plate.

The details of one or more embodiments of the present disclosure are set forth in the accompanying drawings and the description below. Other features, objects and advantages of the present disclosure will become apparent.

### BRIEF DESCRIPTION OF THE DRAWINGS

In order to better describe and explain the embodiments and/or examples of those disclosures disclosed herein, one or more drawings may be referred to. The additional details or examples configured to describe the drawings should not be considered as limiting the scope of any of the disclosed disclosures, the currently described embodiments and/or examples, and the best mode of these disclosures currently understood.

FIG. 1 is a schematic diagram of a positioning platform based on an electromagnetic actuator in an embodiment of the present disclosure.

FIG. 2 is another schematic diagram of a positioning platform based on an electromagnetic actuator in an embodiment of the present disclosure.

FIG. 3 is a schematic diagram of a groove and a permanent magnet in an embodiment of the present disclosure.

In the figures, 1 represents an actuator stator frame; 2 represents an actuator mover; 3 represents a fixed base plate; 4 represents a first speed-increasing gear; 5 represents a second speed-increasing gear; 6 represents an electromagnetic clutch; 7 represents a bearing base; 8 represents a transmission gear; 9 represents a second primary speed gear; 10 represents a primary speed rack gear; 11 represents an speed-increasing rack gear; 12 represents an upper connecting plate; 13 represents a rack; 14 represents a connecting plate; 15 represents a vertical plate; 16 represents a first primary speed gear; 17 represents a transmission rack gear; 18 represents a power shaft; 19 represents a ball; 20 represents a holder; 21 represents a sliding guidance groove; 22 represents a groove; 23 represents a permanent magnet; 30 represents an actuator stator component; 40 represents an actuator mover component; 50 represents a moving platform component; 60 represents a deceleration driving component; 61 represents a mounting bracket; 62 represents a transmission component; and 70 represents a sliding guidance component.

### DETAILED DESCRIPTION OF THE EMBODIMENT

In order to make objects, technical solutions and advantages of the present disclosure more clearly understood, the present disclosure is described and illustrated in the following with reference to the accompanying drawings and embodiments. It should be understood that specific embodiments described herein are only used to explain the present disclosure and not intended to limit the present disclosure. All other embodiments obtained by those skilled in the art based on the embodiments of the present disclosure without making creative labor are within the scope of the present disclosure. It is also understood that although the efforts made in such development process may be complex and lengthy, some changes in design, manufacture or production based on the technical content disclosed in the present disclosure are only conventional technical means to those skilled in the art related to the content disclosed in the present disclosure and should not be construed as inadequate for the content disclosed in the present disclosure.

The reference to “embodiment” in the present disclosure means that with reference to the particular features, structures or characteristics described in the embodiments may be included in at least one embodiment of the present disclosure. The phrase “embodiment” appears in various positions in the description does not necessarily refer to the same embodiment, nor is it a separate or embodiment that is mutually exclusive with other embodiments. It can be expressly and implicitly understood by those skilled in the art that the embodiments described in the present disclosure may be combined with other embodiments in the absence of conflict.

Unless otherwise defined, all technical and scientific terms used herein have the same meaning as a skilled person in the art would understand. The term “one”, “a”, “an”, “the” and other similar words as used in the present disclosure do not indicate quantitative limitations, and they can be singular or plural. The terms “include”, “comprise”, “have”, and any variation thereof, as used in the present disclosure, are intended to cover a non-exclusive inclusion.

It should be noted that when a component is considered to be “mounted” on another component, it may be directly mounted on the other component or an intervening component may be presented. When a component is considered to be “disposed” on another component, it may be directly disposed on the other component or an intervening component may be presented at the same time. When a component is considered to be “fixed” to another component, it may be directly fixed to the other component or an intervening component may be presented at the same time.

The term “plurality” in the present disclosure refers to two or more. The terms “first”, “second”, etc. involved in the present disclosure are only configured for distinguishing similar objects, and do not represent a specific order of the objects.

The present disclosure is described specifically hereinafter in connection with the accompanying drawings and specific embodiments.

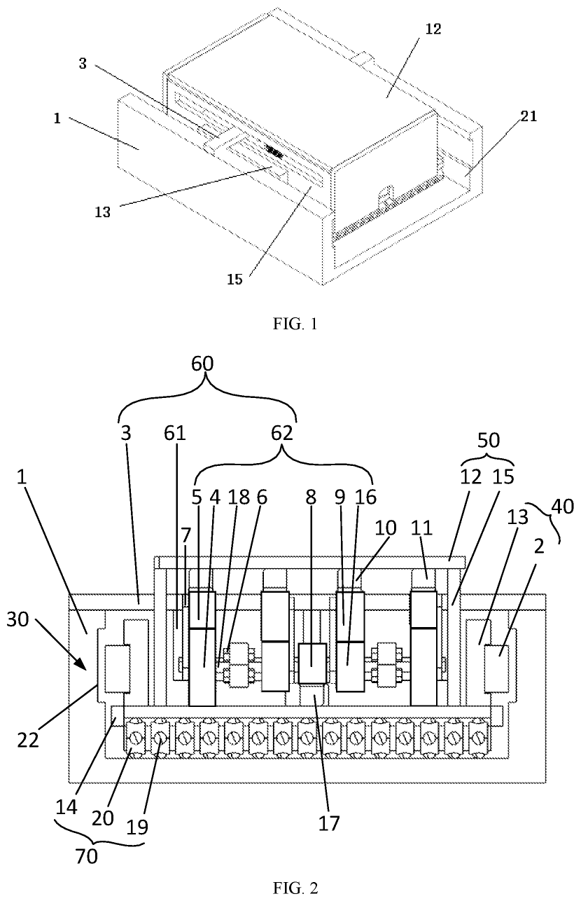

Referring to FIG. 1 and FIG. 2, a positioning platform based on an electromagnetic actuator is provided in the present disclosure. The positioning platform includes an actuator stator component 30, an actuator mover component 40, a moving platform component 50, and a deceleration driving component 60. The actuator stator component 30 is provided with a sliding guidance groove 21. The actuator mover component 40 is disposed in the actuator stator component 30 and capable of sliding by electromagnetic force along the sliding guidance groove 21 defined by the actuator stator component 30. The moving platform component 50 is driven by the actuator mover component 40 to slide along the sliding guidance groove 21 defined by the actuator stator component 30. An end of the deceleration driving component 60 is connected to the actuator mover component 40, and the other end of the deceleration driving component 60 is connected to the moving platform component 50. The actuator mover component 40 is capable of selectively driving the moving platform component 50 to move at different speeds by the deceleration driving component 60. The structure of the above components would be described below.

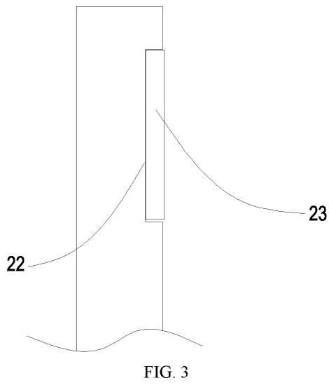

Referring to FIG. 3, in an embodiment, the actuator stator component 30 may include an actuator stator frame 1 and permanent magnets 23 disposed at both sides of the actuator stator frame 1. The actuator mover component 40 may include a rack 13 and actuator movers 2 disposed at both sides of the rack 13, and the actuator movers 2 may be corresponding to the permanent magnets 23. The actuator stator frame 1 may be provided with the sliding guidance groove 21. Solenoid coils may be fixed on both sides of the actuator movers 2. When the solenoid coils are energized, the actuator mover component 40 may move by the electromagnetic force along the actuator stator frame 1. Alternatively, the actuator stator frame 1 may be provided with grooves 22 at both sides, and the grooves 22 are configured to hold the permanent magnets 23, respectively.

In an embodiment, the positioning platform based on the electromagnetic actuator may further include a sliding guidance component 70.

The sliding guidance component 70 may be disposed between the actuator stator component 30 and the actuator mover component 40 and capable of sliding and guiding the actuator mover component 40 to slide. The sliding guidance component 70 may include a connecting plate 14, a plurality of holders 20, and a plurality of balls 19. The connecting plate 14 may be connected to a bottom of the rack 13. The plurality of holders 20 may be disposed on the connecting plate 14 and capable of rolling about axes of the plurality of holders 20 and relative to the connecting plate 14. The plurality of balls 19 may be disposed on the plurality of holders 20 and capable of rolling about axes of the plurality of balls 19 relative to the plurality of holders 20, respectively. The plurality of balls 19 and the plurality of holders 20 may be evenly laid between the rack 13 and the connecting plate 14, which may reduce a distance between fulcrums and reduce a deformation caused by loads. During a linear motion of the rack 13 and the connecting plate 14, the plurality of balls 19 may continuously roll in the holder 20 along a direction of the linear motion, so that the rack 13 and the connecting plate 14 can move linearly and smoothly for a long distance without splicing tracks.

In an embodiment, the deceleration driving component 60 is capable of switching between a first operation mode and a second operation mode. When the deceleration driving component 60 is in the first operation mode, the moving platform component 50 may move at a first speed. When the deceleration driving component 60 is in the second operation mode, the moving platform component 50 may move at a second speed different from the first speed.

In the present disclosure, the deceleration driving component 60 may include a fixed base plate 3, a mounting bracket 61, and a transmission component 62. The fixed base plate 3 may be fixed to the actuator stator frame 1 and configured to guide the moving platform component 50. The mounting bracket 61 may be fixedly connected to the fixed base plate 3. The transmission component 62 may be connected to the mounting bracket 61. The transmission component 62 is capable of switching between a first state and a second state. When the transmission component 62 is in the first state, the deceleration driving component 60 may be in the first operation mode. When the transmission component 62 is in the second state, the deceleration driving component 60 may be in the second operation mode.

Specifically, the transmission component 62 may include a first primary speed gear 16, a second primary speed gear 9, a first speed-increasing gear 4, a second speed-increasing gear 5, a transmission gear 8, a power shaft 18, and an electromagnetic clutch 6. All of the first primary speed gear 16, the second primary speed gear 9, the first speed-increasing gear 4, and the second speed-increasing gear 5 may be rotatably disposed on the mounting bracket 61. The second primary speed gear 9 may be engaged with the first primary speed gear 16 and a primary speed rack gear 10 disposed on the moving platform component 50, respectively. The second speed-increasing gear 5 may be engaged with the first speed-increasing gear 4 and an speed-increasing rack gear 11 disposed on the moving platform component 50, respectively. The power shaft 18 may rotatably extend through the first primary speed gear 16 and the first speed-increasing gear 4. The transmission gear 8 may be connected to the power shaft 18 and engaged with a transmission rack gear 17 disposed on the rack 13. The electromagnetic clutch 6 may be slidably mounted on the power shaft 18 and capable of standstill locking relative to the power shaft, and the electromagnetic clutch 6 may be located between the first primary speed gear 16 and the first speed-increasing gear 4. When the electromagnetic clutch 6 is engaged with the first primary speed gear 16, the electromagnetic clutch 6 may transmit transmission force of the power shaft 18 to the first primary speed gear 16. When the electromagnetic clutch 6 is engaged with the first speed-increasing gear 4, the electromagnetic clutch 6 may transmit the transmission force of the power shaft 18 to the first speed-increasing gear 4.

In this way, when the actuator mover component 40 is in operation, the transmission gear 8 may be driven by the transmission rack gear 17 on the actuator mover component 40. The electromagnetic clutch 6 is capable of sliding between a first position of engagement with the first primary speed gear 16 and a second position of engagement with the first speed-increasing gear 4. When the electromagnetic clutch 6 is engaged with the first primary speed gear 16, the electromagnetic clutch 6 may transmit the transmission force of the power shaft 18 to the first primary speed gear 16, the first primary speed gear 16 may drive the second primary speed gear 9 to move, and the second primary speed gear 9 may drive the moving platform component 50 by the primary speed rack gear 10. Similarly, when the electromagnetic clutch 6 is engaged with the first speed-increasing gear 4, the electromagnetic clutch 6 may transmit the transmission force of the power shaft 18 to the first speed-increasing gear 4, the first speed-increasing gear 4 may drive the second speed-increasing gear 5 to move, and the second speed-increasing gear 5 may drive the moving platform component 50 by the speed-increasing rack gear 11. Since a transmission ratio between the first primary speed gear 16 and the second primary speed gear 9 is different from a transmission ratio between the first speed-increasing gear 4 and the second speed-increasing gear 5, a moving speed of the moving platform component 50 may be different in these two different operating modes. In the present disclosure, the transmission ratio between the first primary speed gear 16 and the second primary speed gear 9 may be 1, and the moving speed of the moving platform assembly 50 may be equal to a moving speed of the rack 13. The transmission ratio between the first speed-increasing gear 4 and the second speed-increasing gear 5 may be less than 1, and the moving speed of the moving platform assembly 50 may be greater than the moving speed of the rack 13.

In an embodiment, the mounting bracket 61 may include a plurality of bearing bases 7, and each bearing base 7 may be provided with a mounting bearing. All of the first primary speed gear 16, the second primary speed gear 9, the first speed-increasing gear 4, and the second speed-increasing gear 5 may be rotatably mounted on the bearing bases 7 via the plurality of mounting bearings, respectively.

Alternatively, the transmission component 62 may include two first primary speed gears 16, two second primary speed gears 9, two first speed-increasing gears 4, two second speed-increasing gears 5, and two electromagnetic clutches 6. The two first primary speed gears 16 may be disposed at both sides of the transmission gear 8, respectively. The two first speed-increasing gears 4 may be disposed at both sides of the two first primary speed gears 16, respectively.

In this way, the rack 13 may drive the moving platform assembly 50 more smoothly and stably.

In the present disclosure, the moving platform assembly 50 may include an upper connecting plate 12 and vertical plates 15 disposed at both sides of the upper connecting plate 12. The fixed base plate 3 may extend through sliding grooves on the vertical plates 15 to guide the vertical plates 15 to slide. Both the primary speed rack gear 10 and the speed-increasing rack gear 11 may be disposed on the upper connecting plate 12.

The positioning platform based on the electromagnetic actuator in the present disclosure may have advantages such as high precision, a variable speed, and a great load. The positioning platform based on the electromagnetic actuator may quickly switch a moving speed of the positioning platform, withstand the great load, and be subjected to less frictional resistance when the positioning platform is moving.

The technical features of the above-described embodiments may be combined in any combination. For the sake of brevity of description, not all possible combinations of the technical features in the above embodiments are described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure. Therefore, the scope of the disclosure should be determined by the appended claims.

We claim:

1. A positioning platform based on an electromagnetic actuator, comprising an actuator stator component, an actuator mover component, a moving platform component, and a deceleration driving component;
wherein the actuator stator component is provided with a sliding guidance groove;
the actuator mover component is disposed in the actuator stator component and capable of sliding by electromagnetic force along the sliding guidance groove defined by the actuator stator component;
the actuator mover component is capable of driving the moving platform component to slide along the sliding guidance groove defined by the actuator stator component; and
an end of the deceleration driving component is connected to the actuator mover component, the other end of the deceleration driving component is connected to the moving platform component, and the actuator mover component is capable of selectively driving the moving platform component to move at different moving speeds by the deceleration driving component.

2. The positioning platform based on the electromagnetic actuator of claim 1, wherein the actuator stator component comprises an actuator stator frame and permanent magnets disposed at both sides of the actuator stator frame; and
the actuator mover component comprises a rack and actuator movers disposed at both sides of the rack, and the actuator movers are disposed corresponding to the permanent magnets.

3. The positioning platform based on the electromagnetic actuator of claim 2, wherein the actuator stator frame is provided with grooves at both sides, and the grooves are configured to hold the permanent magnets.

4. The positioning platform based on the electromagnetic actuator of claim 2, further comprising a sliding guidance component, wherein the sliding guidance component is disposed between the actuator stator component and the actuator mover component and capable of sliding and guiding the actuator mover component to slide.

5. The positioning platform based on the electromagnetic actuator of claim 4, wherein the sliding guidance component comprises a connecting plate, a plurality of holders, and a plurality of balls; and
the connecting plate is connected to a bottom of the rack, the plurality of holders are disposed on the connecting plate and capable of rolling about axes of the plurality of holders and relative to the connecting plate, and the plurality of balls are disposed on the plurality of holders and capable of rolling about axes of the plurality of balls relative to the plurality of holders, respectively.

6. The positioning platform based on the electromagnetic actuator of claim 2, wherein the deceleration driving component is capable of switching between a first operation mode and a second operation mode;
when the deceleration driving component is in the first operation mode, the moving platform component moves at a first speed; and
when the deceleration driving component is in the second operation mode, the moving platform component moves at a second speed different from the first speed.

7. The positioning platform based on the electromagnetic actuator of claim 6, wherein the deceleration driving component comprises a fixed base plate, a mounting bracket, and a transmission component;
the fixed base plate is fixed to the actuator stator frame and configured to guide the moving platform component, the mounting bracket is fixed to the fixed base plate, and the transmission component is connected to the mounting bracket; and
the transmission component is capable of switching between a first state and a second state, when the transmission component is in the first state, the deceleration driving component is in the first operation mode, and when the transmission component is in the second state, the deceleration driving component is in the second operation mode.

8. The positioning platform based on the electromagnetic actuator of claim 7, wherein the transmission component comprises a first primary speed gear, a second primary speed gear, a first speed-increasing gear, a second speed-increasing gear, a transmission gear, a power shaft, and an electromagnetic clutch;
the first primary speed gear, the second primary speed gear, the first speed-increasing gear, and the second speed-increasing gear are rotatably disposed on the mounting bracket;
the second primary speed gear is engaged with the first primary speed gear and a primary speed rack gear disposed on the moving platform component, respectively;
the second speed-increasing gear is engaged with the first speed-increasing gear and an speed-increasing rack gear disposed on the moving platform component, respectively;
the power shaft rotatably extends through the first primary speed gear and the first speed-increasing gear;
the transmission gear is connected to the power shaft and engaged with a transmission rack gear disposed on the rack;
the electromagnetic clutch is slidably mounted to the power shaft and capable of standstill locking relative to the power shaft, and the electromagnetic clutch is located between the first primary speed gear and the first speed-increasing gear;
when the electromagnetic clutch is engaged with the first primary speed gear, the electromagnetic clutch transmits a transmission force of the power shaft to the first primary speed gear; and
when the electromagnetic clutch is engaged with the first speed-increasing gear, the electromagnetic clutch transmits the transmission force of the power shaft to the first speed-increasing gear.

9. The positioning platform based on the electromagnetic actuator of claim 8, wherein the transmission component comprises two first primary speed gears, two second primary speed gears, two first speed-increasing gear, two second speed-increasing gear, and the electromagnetic clutch;
the two first primary speed gears are disposed at both sides of the transmission gear, respectively; and
the two first speed-increasing gears are disposed at both sides of the two first primary speed gears, respectively.

10. The positioning platform based on the electromagnetic actuator of claim 9, wherein the moving platform component comprises an upper connecting plate and vertical plates disposed at both sides of the upper connecting plate;
the fixed base plate extends through sliding grooves on the vertical plates to guide the vertical plates to slide; and
both the primary speed rack gear and the speed-increasing rack gear are disposed on the upper connecting plate.
